(19) United States
(12) Patent Application Publication
(10) Pub. No.: US 2012/0272818 A1
(43) Pub. Date: Nov. 1, 2012

(54) SUPPRESSOR WITH CRENELATED FRONT

(75) Inventors: Barry W. Dueck, Sunset Beach, CA (US); Karl R. Honigmann, Anaheim Hills, CA (US); Brooke C. Smith, Fountain Valley, CA (US); John W. Matthews, Newport Beach, CA (US)

(73) Assignee: SureFire, LLC, Fountain Valley, CA (US)

(21) Appl. No.: 13/281,350

(22) Filed: Oct. 25, 2011

Related U.S. Application Data
(63) Continuation-in-part of application No. 12/482,664, filed on Jun. 11, 2009, now Pat. No. 8,091,462.
Application No. 12/482,664 is a continuation-in-part of application No. 13/102,819, filed on May 6, 2011, now Pat. No. 8,209,895.
Application No. 13/102,819 is a continuation of application No. 12/582,958, filed on Oct. 21, 2009, now Pat. No. 7,946,069.
Application No. 12/582,958 is a continuation of application No. 11/171,178, filed on Jun. 29, 2005, now Pat. No. 7,676,976.
Application No. 11/171,178 is a continuation-in-part of application No. 10/703,971, filed on Nov. 6, 2003, now Pat. No. 6,948,415.

(51) Int. Cl. F41A 21/30; B23P 15/00

(52) U.S. Cl. 89/14.4; 181/223; 29/896.2

(57) ABSTRACT

A device can include a noise suppressor for a firearm. The noise suppressor can have a front end and at least one protrusion extending from the front end. The noise suppressor can have a plurality of protrusions. For example, a plurality of spikes can be formed upon the front end of the noise suppressor. The protrusions can be configured to be useful for self-defense or other purposes.

### CROSS-REFERENCE TO RELATED APPLICATIONS

This patent application is a continuation-in-part of U.S. patent application Ser. No. 12/482,664 filed on Jun. 11, 2009 and entitled FIREARM ATTACHMENT LOCKING SYSTEM, which is hereby expressly incorporated by reference in its entirety.

This patent application is a continuation-in-part of U.S. patent application Ser. No. 13/102,819 filed on May 6, 2011 and entitled SYSTEMS FOR ATTACHING A NOISE SUPPRESSOR TO A FIREARM, which is a continuation of U.S. patent application Ser. No. 12/582,958 filed on Oct. 21, 2009 and entitled SYSTEMS FOR ATTACHING A NOISE SUPPRESSOR TO A FIREARM (issued May 24, 2011 as U.S. Pat. No. 7,946,069), which is a continuation of U.S. patent application Ser. No. 11/171,178 filed on Jun. 29, 2005 and entitled SYSTEMS FOR ATTACHING A NOISE SUPPRESSOR TO A FIREARM (issued Mar. 16, 2010 as U.S. Pat. No. 7,676,976), which is a continuation-in-part of U.S. patent application Ser. No. 10/703,971 filed on Nov. 6, 2003 and entitled SYSTEM FOR ATTACHING A NOISE SUPPRESSOR TO A FIREARM (issued Sep. 27, 2005 as U.S. Pat. No. 6,948,415), which are all hereby expressly incorporated by reference in their entirety.

### TECHNICAL FIELD

This application relates to firearms, and more particularly to a firearm noise suppressor.

### BACKGROUND

Firearm suppressors conventionally include a plurality of baffles contained within a cylindrical housing that attaches to the distal end of the gun barrel. The baffles function to reduce the pressure and velocity of propellant gases so as to suppress gun muzzle blasts. An industry-standard baffle is known as a K baffle and has been in widespread use since the 1980's. As seen in FIG. 1, a K baffle 100 includes a flat disc-shaped baffle 105 connected to a distally-facing cone 110 such that a cross-sectional view (not illustrated) of baffle 100 is K-shaped. To slow and deflect the propellant gases produced from a fired cartridge, the bore of baffle 100 has slanted sidewalls 115. Propellant gas is thus deflected away from traveling down the bore of cone 110 and behind baffle 105 instead. In this fashion, the gun muzzle blast is effectively muzzled as the explosive pressure wave from an unsuppressed gun blast is transformed into a lower pressure wave of a greater duration.

Although K baffles have proven to be quite popular, a number of problems remain unresolved. For example, a K baffle uses a substantial amount of metal and thus makes the resulting suppressor relatively heavy. In addition, the disc-shaped baffle 105 must seal against the cylindrical housing that contains the baffles such that baffle 105 is aligned orthogonally with respect to the longitudinal axis of the cylindrical housing. This alignment is difficult to maintain properly during manufacture and is adversely affected by gun blast pressures.

Often, when a suppressor is attached to a firearm, a bayonet cannot be attached to the firearm. Because of this, as well as for other reasons, it would be beneficial to provide a suppressor having features that are useful for self-defense, e.g., hand-to-hand combat. Further, it can be beneficial to provide a suppressor having features that are useful for other purposes, such as breaking windows, clearing broken glass from windows, etc.

Furthermore, as an example, there is a need in the art for suppressor baffles that are self-centering and offer reduced weight while improving the gun muzzle blast suppression of conventional K-shaped baffles. There is also a need in the art for a suppressor having features that are useful for purposes other than noise suppression.

### SUMMARY

In accordance with an embodiment, a device can comprise a suppressor for a firearm. The suppressor can have a front end and at least one protrusion extending from the front end. For example, a plurality of spikes can be formed upon the front end of the suppressor. The protrusions can be configured to be useful for self-defense, e.g., can be configured to define a weapon, and can be useful for other purposes. Thus, the protrusions can be used to gouge or gore an opponent in hand-to-hand combat, for example.

In accordance with an embodiment, a method can comprise providing a suppressor and attaching at least one protrusion to the suppressor. The protrusions can be attached to the suppressor such that the protrusions extend from the front end of the suppressor in a manner that is useful for self-defense and other purposes.

In accordance with an embodiment, a method can comprise providing a suppressor having at least one protrusion and attaching the suppressor to a firearm. The protrusions can extend from a front end of the suppressor. The protrusions can be configured to be useful for self-defense and other purposes.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE FIGURES

FIG. 1 is a perspective view of a conventional K-shaped baffle.

FIG. 2 is a perspective view of a proximal end of a poly-conical baffle, according to an embodiment.

FIG. 3 is a perspective view of a distal end of the poly-conical baffle of FIG. 2, according to an embodiment.

FIG. 4 is a cross-sectional view of the poly-conical baffle of FIG. 2, according to an embodiment.

FIG. 5 is cross-sectional view of a suppressor including a plurality of poly-conical baffles spaced apart by spacers, according to an embodiment.

FIG. 6a is a cross-sectional view of a pair of interlocked poly-conical baffles, according to an embodiment.

FIG. 6b is a perspective view of the proximal end for one of the interlocking poly-conical baffles of FIG. 6a, according to an embodiment.

FIG. 7 is a cross-sectional view of a suppressor including a plurality of interlocked poly-conical baffles, according to an embodiment.

FIG. 8 is a perspective view of a plurality of an interlocked suppressor assembly prior to its insertion into the cylindrical housing, according to an embodiment.

FIG. 9 is a perspective view of the proximal end of the suppressor of FIG. 7, according to an embodiment.

FIG. 10 is a perspective view of the suppressor of FIG. 7 having its end caps engaged by spanner wrenches, according to an embodiment.

FIG. 11 is a perspective view of the suppressor of FIG. 7 having its distal end cap removed so as to threadably engage with a disassembly tool, according to an embodiment.

FIG. 12 is a perspective view of a suppressor having crenelations, according to an embodiment.

FIG. 13 is a perspective view of the suppressor of FIG. 12, according to an embodiment.

FIG. 14 is a front elevational view of the suppressor of FIG. 12, according to an embodiment.

FIG. 15 is a rear elevational view of the suppressor of FIG. 12, according to an embodiment.

FIG. 16 is a side elevational view of the suppressor of FIG. 12, according to an embodiment.

FIG. 17 is a side elevational view of the suppressor of FIG. 12, according to an embodiment.

FIG. 18 is a top elevational view of the suppressor of FIG. 12, according to an embodiment.

FIG. 19 is a bottom elevational view of the suppressor of FIG. 12, according to an embodiment.

FIG. 20 is a side view of the suppressor of FIG. 12 attached to a firearm, according to an embodiment.

FIG. 21 is a partially exploded perspective view of an attachment system of a suppressor, according to an embodiment.

FIG. 22 is a cross-sectional end view of a portion of the attachment system of FIG. 21, according to an embodiment.

FIG. 23 is a cross-sectional end view of a portion of an attachment system for longitudinally and radially locking a suppressor to a firearm, according to an embodiment.

Embodiments of the present invention and their advantages are best understood by referring to the detailed description that follows. It should be appreciated that like reference numerals are used to identify like elements illustrated in one or more of the figures.

### DETAILED DESCRIPTION

A poly-conical baffle is provided that is self-centering through the interaction of a forward-facing conical baffle and a rear-facing conical baffle. As these conical baffles are longitudinally loaded within a cylindrical gun suppressor housing, they naturally flex towards each other due to their opposite alignments. Such flexing causes the base of each conical baffle to wedge against the inner diameter of the gun suppressor housing. In this fashion, each poly-conical baffle is self-centering within the gun suppressor housing and maintains its alignment in the face of propellant gas pressures. Indeed, propellant gas pressures aid the conical baffles in flexing against one another to further wedge the baffles against the gun suppressor housing.

In another embodiment, the baffles are modified such that successive poly-conical baffles removably interlock with each other. The self-centering embodiment will be described first followed by a description of the interlocking embodiment.

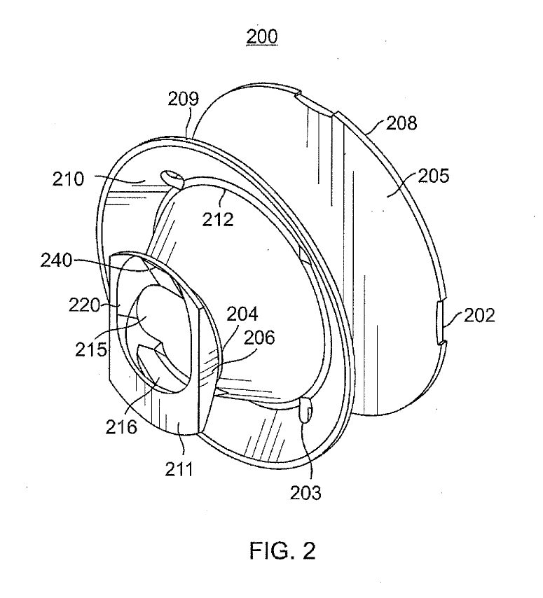

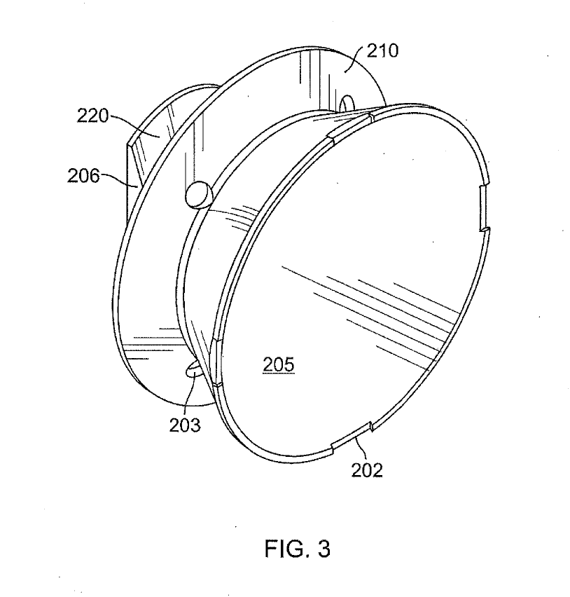

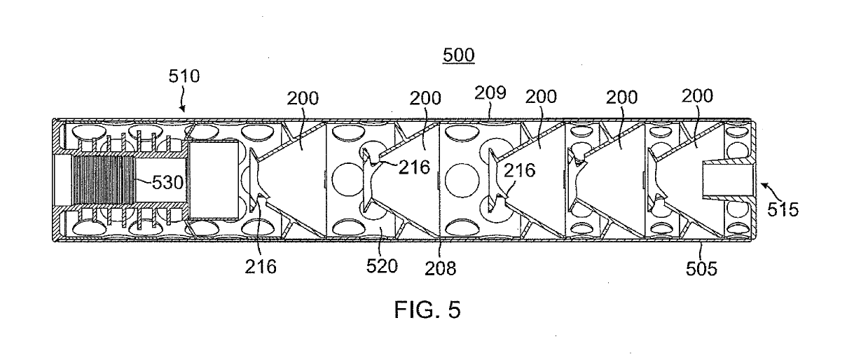

Turning now to the drawings, an example poly-conical baffle 200 is shown in FIGS. 2 and 3. A forward-facing conical baffle 205 extends from an apex 204 towards a base 208. As used herein, an “apex” for a conical baffle refers to the narrower end whereas a “base” refers to the wider end of each conical baffle. Conical baffle 205 is denoted to be forward facing because the base distally faces away from the gun or firearm barrel. In contrast, a rear-facing conical baffle 210 proximally extends from an apex 212 to a base 209 such that base 209 faces the gun barrel. Because forward-facing baffle 205 extends through apex 212 and base 209 of baffle 210, baffle 210 forms a cylindrical collar around baffle 205. Bases 208 and 209 each have a circumference sized to match the inner circumference of a cylindrical housing (discussed below with regard to FIG. 5) for the resulting suppressor. Apex 204 of baffle 205 includes a central bore 215. Central bore 215 also extends through a truncated rear-facing conical baffle 220 that shares apex 204 for baffle 205. A flattened face 211 forms a base for baffle 220.

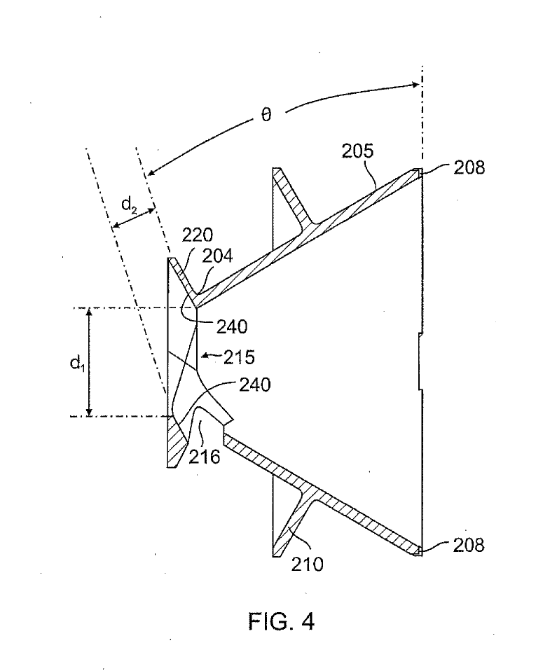

As seen in the cross-sectional view of FIG. 4, central bore 215 has a diameter d₁ through apex 204 of both truncated baffle 220 and forward-facing baffle 205. This diameter must, of course, be sufficient as determined by the gun caliber to allow the corresponding bullet to pass unhampered through the baffles. Truncated conical baffle 220 has slanted sidewalls 240 that direct propellant gases to a port 216 through apex 204. For example, a first end mill corresponding to diameter d₁ may form bore 215. This first milling is performed along the longitudinal axis that is orthogonal to a vertical plane defined by base 208 of forward-facing frustum baffle 205. A second end mill oriented at a relatively shallow angle θ such as 30° to the vertical plane and corresponding to a smaller-than-d₁ diameter d₂ may form slanted sidewalls 240. For example, in a 9 mm embodiment, diameter d₁ may be 0.390 inch whereas diameter d₂ may be 0.250 inch.

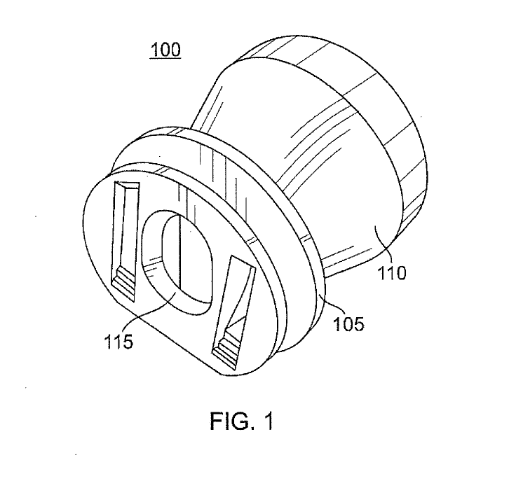

Referring back to FIG. 1, conventional K baffle 100 also has slanted sidewalls for the central bore. It can be seen, however, that the slant for such sidewalls is typically around 45 degrees. Keeping angle θ for truncated conical baffle 220 at a relatively shallow angle such as 30 degrees substantially reduces a necessary length for truncated baffle 220 to thereby reduce the corresponding weight for resulting conical baffle 200. Referring again to FIG. 2, a width for flat face 211 for truncated conical baffle 220 is less than a width for bases 208 and 209, which also reduces the mass for complete baffle 200. For example, a width for flat face 211 may be approximately one-half that for bases 208 and 209 (and hence approximately one-half of the inner diameter for a corresponding cylindrical housing as discussed further with regard to FIG. 5). Baffle 220 is partially removed on its sides to form flat surfaces 206 to help funnel propellant gases across central bore 215 and thus further slow the passage of gas through the resulting suppressor.

Slanted sidewalls 240 direct propellant gases through port 216 and against the collar formed by baffle 210. Thus, the bulk of gases vented through port 216 must circulate around baffle 220 to re-enter central bore 215. Moreover, because flat face 211 of baffle 220 has a relatively small width as compared to bases 208 and 209, a considerable portion of the propellant gases bypass central bore 215 initially and instead are directed directly against baffle 210. This delays the passage of gas from behind baffle 220 and creates greater sound suppression than offered by conventional K baffle 100. To prevent excessive pressure building up behind baffle 210, several relief passages 203 may be provided in baffle 210. Similarly, forward-facing conical baffle 205 includes a plurality of slot-shaped vents 202. It is desirable for a suppressor to not only suppress the gun blast but also the associated flame. Thus, slot-shaped vents 202 have a depth of less than 0.016 inch in one embodiment to prevent flame from passing through them.

Referring now to FIG. 5, a suppressor 500 includes a plurality of poly-conical baffles 200. In this embodiment, there are a total of five poly-conical baffles 200, but it will be appreciated that the total number of poly-conical baffles 200 is a design choice and involves a tradeoff between increased sound suppression (more baffles) versus lower weight (less baffles). A cylindrical housing 505 has an inner diameter that substantially matches a diameter for bases 208 and 209 discussed with regard to FIGS. 2 and 3. To aid in the delay of propellant gases through suppressor 500, ports 216 may be oriented at 180 degrees with respect to neighboring baffles 200. Thus, a first port may be deemed as directed “downwards,” an adjacent port may be deemed as directed “upwards,” and so on. A rear or proximal cap 510 and a front or distal cap 515 seal baffles 200 within housing 505. Rear cap 510 includes threads 530 or other means to allow a user to secure suppressor 500 to a corresponding gun barrel. Perforated annular spacers 520 abut against poly-conical baffles 200 and the end caps 510 and 515 to position each baffle as desired (depending upon the length of each adjacent spacer) within housing 505. For each poly-conical baffle 200, a proximal spacer 520 abuts against base 209 whereas a distal spacer 520 abuts against base 208. During assembly, the stacked spacers 520 and poly-conical baffles 200 may be longitudinally compressed within housing 505 to ensure that the baffles self-center within the housing. Caps 510 and 515 may then be welded or otherwise secured to housing 505 to permanently seal suppressor 500. In an alternative embodiment, end caps 510 and 515 could threadably engage housing 505. However, housing 505 would then require greater thickness to accommodate the threads, which adds to bulk and thus requires a reduction of the baffle size and suppression efficiency accordingly. All components for suppressor 500 may be constructed from titanium for strength and weight savings. Alternatively, other metals or composite materials may be used to construct suppressor 500.

Regardless of what material is used to construct suppressor 500, it may immediately be appreciated that the resulting construction is lighter than a suppressor having a corresponding number of K baffles of the same material. Despite being lighter, suppressor 500 offers better gun blast suppression as compared to a K-baffle containing suppressor.

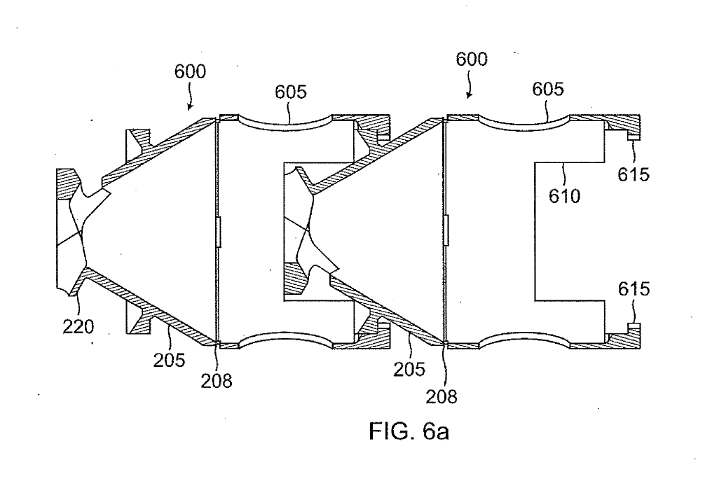

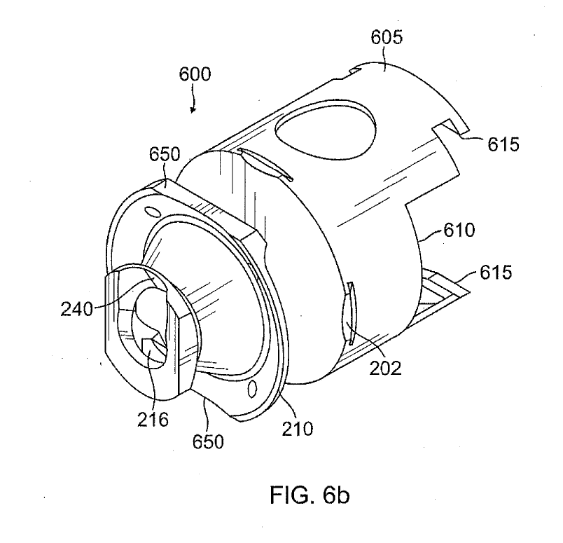

Although welding avoids having to introduce threads into the cylindrical housing, it prevents a user from taking the resulting permanently-assembled suppressor apart for cleaning and maintenance. To provide an ability to disassemble the resulting suppressor, two interlocking poly-conical baffles 600 are shown in FIG. 6a that are integral with their spacers 605. Base 208 of forward-facing conical baffle 205 thus attaches to a proximal end of spacer 605. The interlocking nature of these poly-conical baffles advantageously provides for a readily assembled and disassembled suppressor as will be discussed further herein. Each spacer 605 includes a cutout 610 to receive the rear facing conical baffle 210 discussed previously. Baffle 210 is thus modified to mate with cutout 610 as seen in FIG. 6b. For example, a distal end of each spacer 605 may include a lip or shelf 615 configured to engage with rear-facing conical baffle 210 of an adjoining poly-conical baffle. Thus, baffle 210 is modified to include flat faces 650 to enable baffle 210 to engage with lip 615. To connect two poly-conical baffles 600, a user would thus merely slide one of the baffles through cutout 610 to engage lip 615 of the remaining baffle. Similarly, the user may then slide them apart for cleaning and maintenance.

As seen in FIG. 6b, flat faces 650 may be oriented in the same linear direction as defined by slanted sidewalls 240. Thus, port 216 will be adjacent one of flat faces 650. Such an alignment means that ports 216 are either all aligned in the resulting suppressor or preferably can be 180 degrees out of phase as discussed with regard to FIG. 5. In general, an orientation of ports 216 in an up-down-up-down opposing fashion as discussed above provides significant gun blast suppression in that a portion of the combustion gas flow is thus forced to change direction from baffle to baffle, thereby spreading the resulting pressure wave out over time. Poly-conical baffles 600 can thus be configured such that a user is forced to alternate ports in this fashion. Alternatively, the poly-conical baffles may be constructed symmetrically such that a user may experiment to find the port orientation that provides the greatest suppression. As discussed previously, forward-facing poly-conical baffles 205 may include a plurality of slot-shaped vents 202 to vent pressure building up between baffles 205 and 210. Advantageously, such vents may have a depth of less than 0.016 inch to suppress flame production by the resulting suppressor.

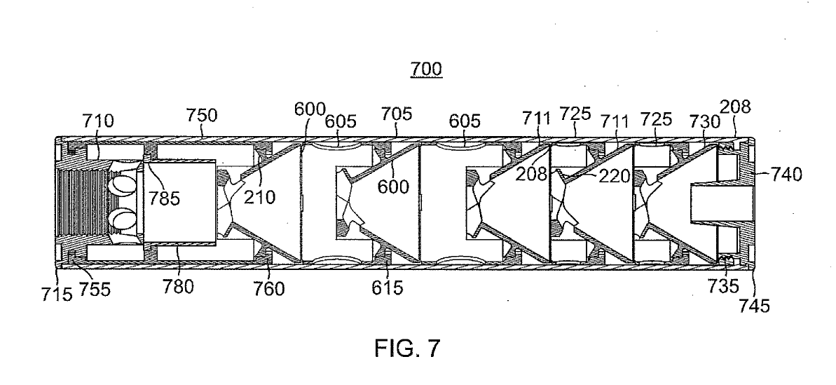

A suppressor 700 including five interlocking poly-conical baffles contained within a cylindrical housing 705 is shown in FIG. 7. Depending upon whether a given poly-conical baffle is distal or proximal within suppressor 700, the spacer length is varied. In that regard, the pressures from the combustion gases are higher in the proximal portions of the suppressor. Thus, a pair of rear-most proximal poly-conical baffles 600 has relatively longer spacer 605 lengths. However, the next two poly-conical baffles 711 in the forward direction have spacers 725 that are relatively shorter. Indeed, spacers 725 have a length such that a base for rear-facing truncated conical baffle 220 of the next poly-conical baffle is virtually flush with the rearward spacer's base 208. A distal-most baffle 730 need not include a spacer but instead has base 208 connect to a threaded collar 735. A front cap 740 threadably engages collar 735 during assembly of suppressor 700 as discussed further herein. A rear-most poly-conical baffle 600 has its baffle 210 engage with a rear spacer 750. Rear spacer 750 thus has a forward cutout analogous to cutout 610 in FIG. 6 to receive the rear-most poly-conical baffle. A cutout in rear spacer 750 receives a read end cap 710. Referring back to FIG. 6, it may be seen that an analogous poly-conical baffle length progression is used in suppressor 500.

Rear end cap 710 includes a collar 715 adapted to engage a proximal or rear end of housing 705. Cap 710 also includes an annular recess shaped to engage with a lip or shelf 755 formed in the rear cutout of spacer 750. Each proximal component thus slidably engages through a cutout in the adjacent distal component. In other words, rear cap 710 engages with lip 755 of rear spacer 750. In turn, rear spacer 750 has a distal lip or shelf 760 that engages with conical baffle 210 for the rear-most poly-conical baffle 600. Each successive poly-conical baffle thus has its conical baffle 210 engage with the collar 615 of the proximal poly-conical baffle.

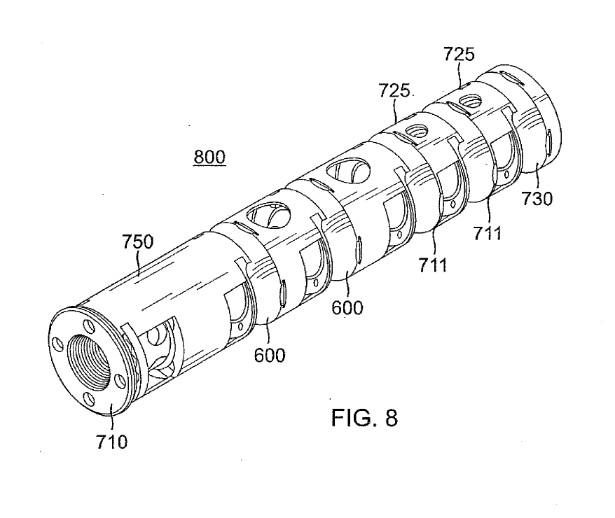

A user would thus engage and stack components 710, 750, 600, 711, and 730 to form a baffle core assembly 800 as shown in FIG. 8. The resulting suppressor assembly is then inserted into housing 705 until collar 715 abuts against a proximal end face of housing 705. Distal or front end cap 740 may then be threadably engaged with threads 735 on distal-most poly-conical baffle 730 until a collar 745 on front end cap 740 engages a distal end face of housing 705. Housing 705 is thus longitudinally compressed whereas the poly-conical baffles in assembly 800 are longitudinally stretched. Although such a stretching does not exploit the self-centering nature of the opposing conical baffles discussed previously, the integral spacers and the interlocking nature of the poly-conical baffles in assembly 800 keeps them properly aligned.

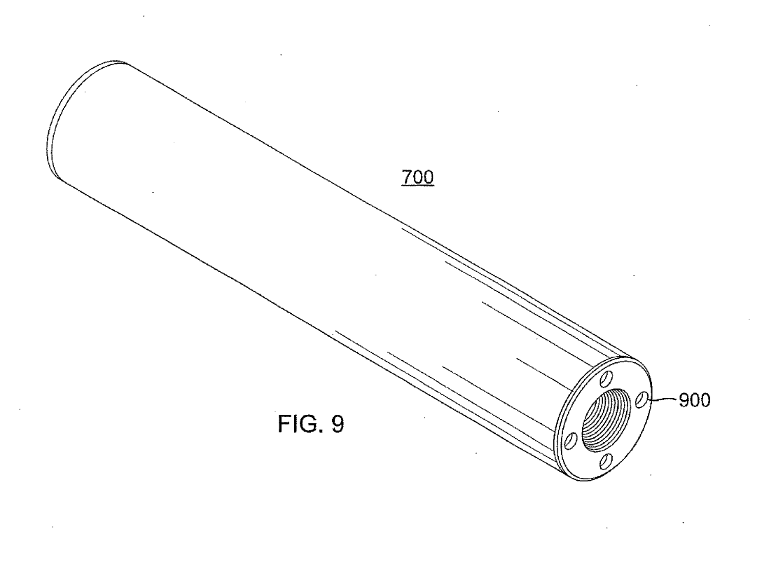

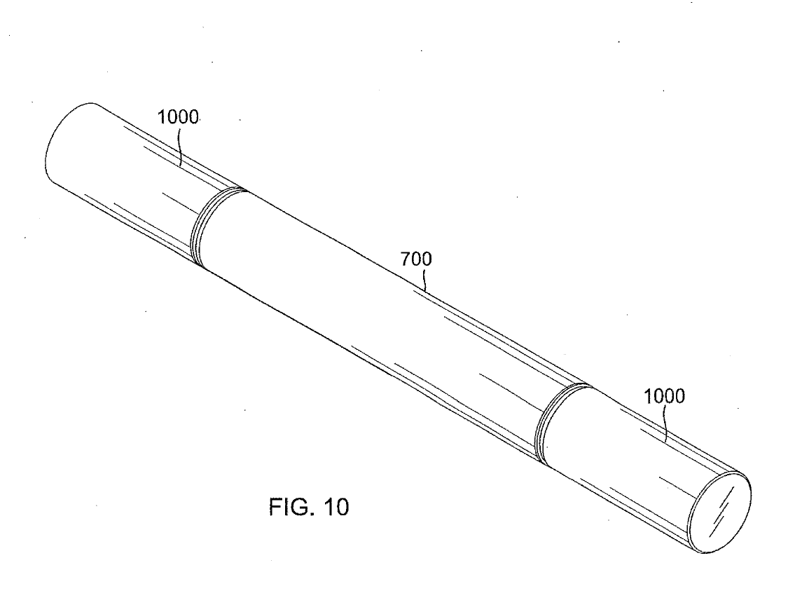

Various means may be used to enable a wrench or spanner to tighten front end cap 740 while securing rear end cap 710 so as to prevent assembly 800 from turning while front end cap 740 is rotated. For example, as seen in FIG. 9, each end cap can include a plurality of spanner cuts 900. A user would thus engage spanner cuts 900 on each end cap with an appropriate spanner wrench 1000 as shown in FIG. 10 to complete assembly of suppressor 700.

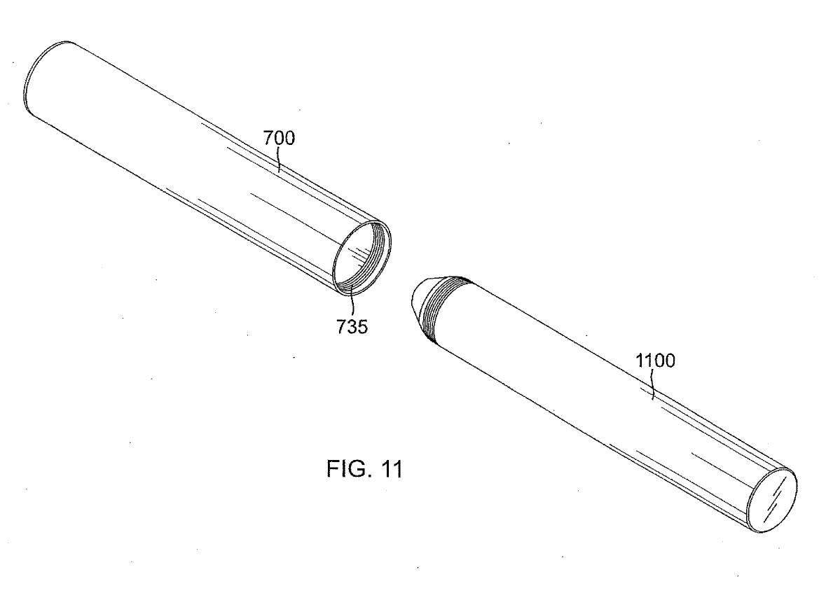

To disassemble the suppressor, the spanner wrenches may be used to remove the end caps. As shown in FIG. 11, a disassembly tool 1100 may then be threaded with threads 735 (FIG. 7) on poly-conical baffle 730. Striking the end of tool 1100 on a hard surface while grasping housing 705 will thus drive assembly 800 out of housing 705, whereupon a user may slide the various components as discussed above to complete disassembly.

End caps 740 and 710 hold housing 705 in compression while interlocked suppressor assembly 800 rests with considerable friction along the inside diameter of housing 705. Thus, the torque to turn housing 705 relative to the remainder of suppressor assembly 800 is high relative to the torque needed to install or remove the suppressor from the gun barrel. Such a relationship prevents a user from having the rear plug unthread from the housing (leading to possible dumping of associated components) while a user tries to remove the suppressor from a gun barrel.

Referring again to FIG. 7, rear spacer 750 may be configured to receive an optional cylindrical insert 780. Insert 780 may include a shoulder or collar 785 that engages with spacer 750 and prevents further distal displacement of the insert. Rear end cap 710 abuts insert 780 and thus prevents any proximal displacement of the insert upon assembly of suppressor 700. Such an insert advantageously allows a user to experiment in that although it will generally aid suppression, there may be certain gun calibers and configurations in which a user may wish to leave insert 780 out of the suppressor assembly.

The poly-conical baffles disclosed herein are considerably lighter than comparable K baffles yet offer even greater gun blast suppression. Moreover, the advantageous efficiency of such poly-conical baffles reduces the “first round pop” problem that otherwise reduces the sound suppression prior to the oxygen being exhausted in a suppressor during the course of repeated firings. In addition, the poly-conical baffles are either self-centering or can be modified so as to be interlocking and thus inherently aligned within the suppressor's cylindrical housing.

Thus, according to an embodiment, a suppressor can comprise a poly-conical baffle having a distal end and an opposing proximal end. The baffle can comprise a forward-facing conical baffle facing the distal end. An opposing rear-facing conical baffle can face the proximal end. The forward-facing baffle can extend through the rear-facing baffle such that the rear-facing baffle forms a collar around the forward-facing baffle. A truncated rear-facing conical baffle can face the proximal end and can have an apex adjoining an apex for the forward-facing conical baffle. A central bore can have slanted sidewalls that extend through the truncated rear-facing conical baffle.

Often, when a suppressor is attached to a firearm, a bayonet cannot be attached to the firearm. Because of this reason, as well as for other reasons, it is beneficial to provide a suppressor having features that are useful for self-defense, e.g., hand-to-hand combat. The features can define or at least partially define a weapon. It is also beneficial to provide a suppressor having features that are useful for self-defense even if a bayonet can be attached to the firearm along with a suppressor. It is also beneficial to provide a suppressor having features that are useful for various different tasks that can be performed in battlefield and police situations, such as breaking windows and clearing glass from the broken windows.

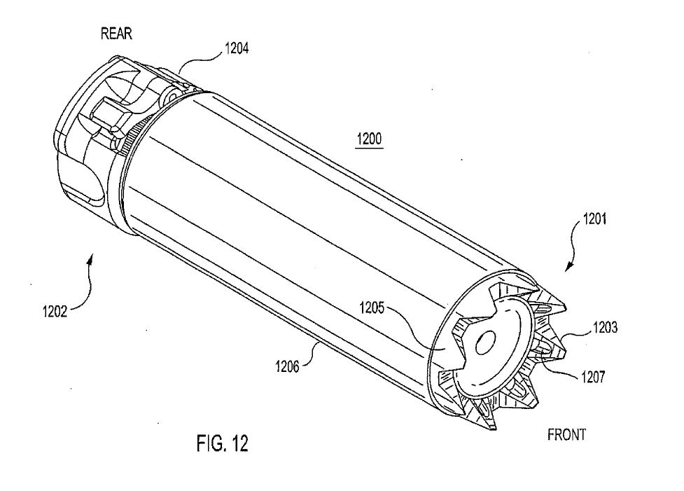

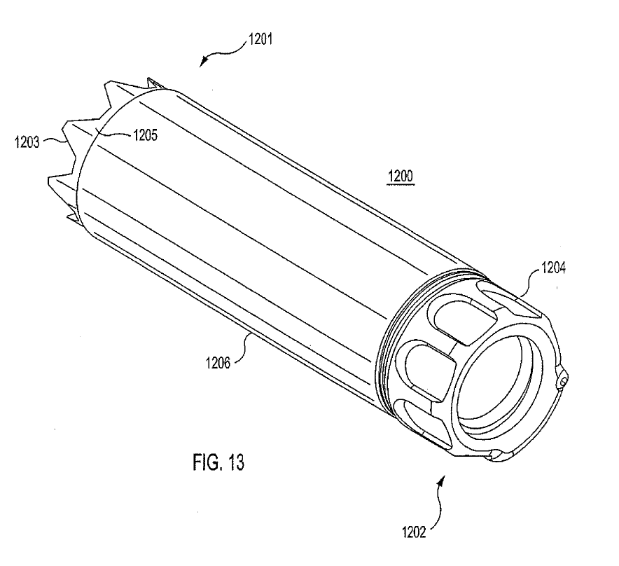

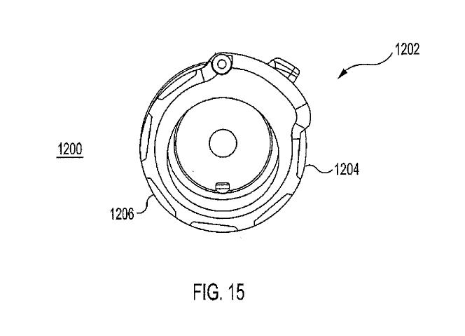

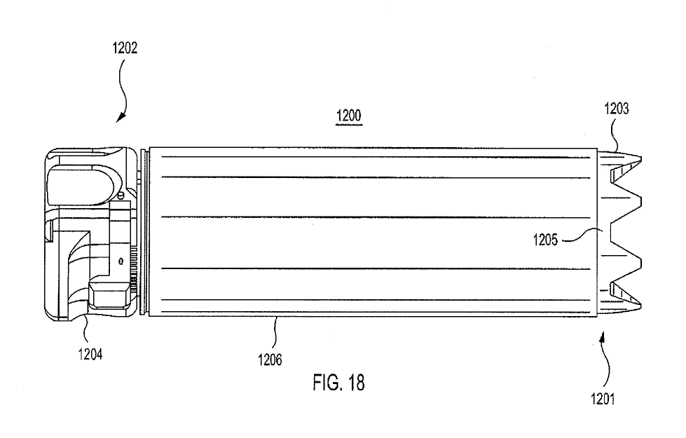

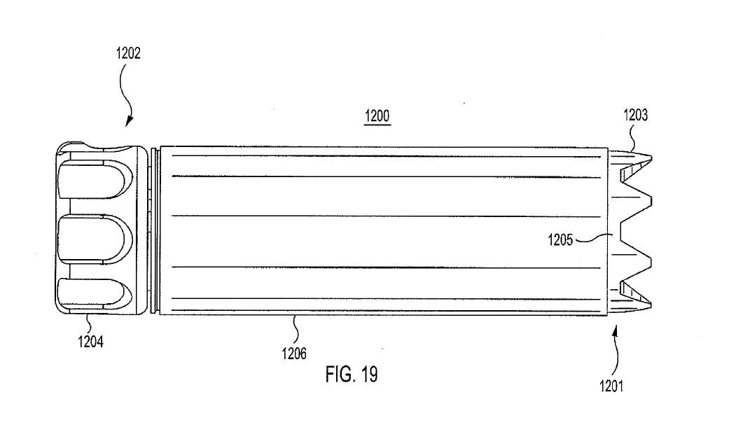

Referring now to FIGS. 12-20, a suppressor 1200 has features that, for example, can be useful for self-defense, e.g., can define a weapon, according to an embodiment. Such features can be useful in hand-to-hand combat, for example. The features can also be used for other activities such as breaking windows and clearing glass from the broken windows.

With particular reference to FIGS. 12-14, the suppressor 1200 can have a front end 1201 and a rear end 1202. The front end 1201 can have at least one protrusion 1203 formed thereon. The front end 1201 can have any number of protrusions 1203 formed thereon. For example, the front end 1201 can have one, two, three, four, five, six, seven, eight, or more protrusions 1203 formed thereon.

The protrusions 1203 can be spikes, for example. The protrusions 1203 can be rods, prongs, knifes, knife edges, nails, hooks, barbs, or any other desired features. The protrusion(s) 1203 can define one or more bayonets. The protrusions 1203 can be configured so as to stab, scrape, scratch, cut, gouge, gore, maim, wound or otherwise tend to harm, hurt, or disable an opponent during hand-to-hand combat. The protrusions 1203 can be configured so as to perform any other desired function.

For example, the protrusions 1203 can have pointed distal ends and/or knife edge distal ends. The protrusions 1203 can have any desired shape and can be configured to perform any desired function. The protrusions 1203 can be substantially identical with respect to one another. The protrusions 1203 can be substantially different with respect to one another.

The protrusions 1203 can define a plurality of crenelations therebetween. The protrusions 1203 have distal ends that are blunt. The protrusions 1203 have distal ends that are not blunt, e.g. are sharp and/or pointed.

The protrusions 1203 can have distal ends that are blunt in one dimension and that define a knife edge in another dimension. The protrusions 1203 can have distal ends that are blunt in a first dimension and that define a knife edge in second dimension, wherein the first dimension is substantially orthogonal with respect to the second dimension. The knife edge can be straight, curved, wavy, or serrated. The knife edge can have saw teeth or any other features formed thereon.

The protrusions 1203 can between 0.1 inch long and three inches long. For example, the protrusions 1203 can be approximately 0.5 inch long. The protrusions can have any desired length.

A knife, bayonet, or other structure can be defined by one or more of the protrusions 1203 and can be longer than three inches. For example, a bayonet can be defined by one or more of the protrusions 1203 and can be between 6 inches and 18 inches long.

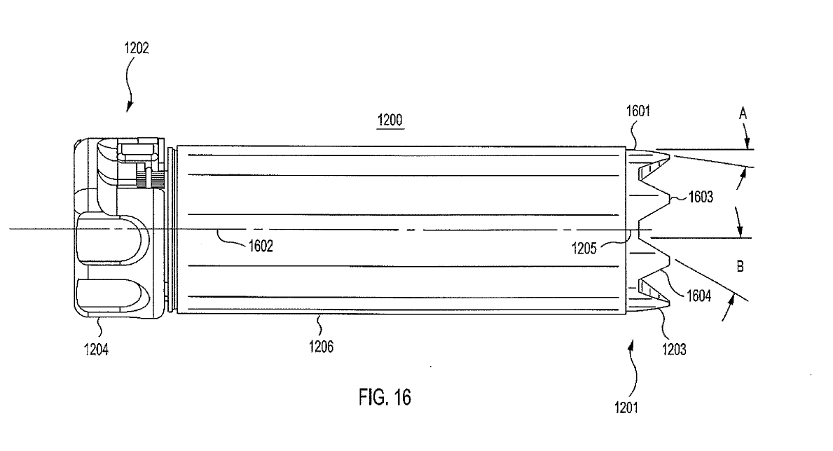

With particular reference to FIG. 16, the protrusions 1203 can have an outboard or outer surface 1601. The outer surface 1601 can be slanted inwardly at an angle (Angle A of FIG. 16). The outer surface 1601 can be slanted inwardly at an angle (Angle A) of approximately 10 degrees with respect to a line that is parallel to a longitudinal axis 1602 of the suppressor 1200, for example. The outer surface 1601 can slant inwardly at any desired angle.

The outer surface 1601 can slant outwardly at any desired angle. The outer surface 1601 can slant outwardly such that the outer surface 1601 is approximately orthogonal with respect to the longitudinal axis 1602. Alternating outer surfaces 1601 can slant inwardly and outwardly. The outer surface 1601 can substantially lack any slant at all. Any combination of slants can be used for the outer surfaces 1601 of the protrusions 1203.

The entire protrusions 1203 themselves (rather than just the outer surface 1601 thereof, as discussed above) can slant outwardly at any desired angle, can slant inwardly at any desired angle, or can substantially lack any slant at all. Alternating protrusions 1203 can slant inwardly and outwardly. Any combination of slants can be used for the protrusions 1203.

The protrusions 1203 can have tips 1603 and sides 1604. The sides 1604 can be slanted toward the tips 1603 at an angle (Angle B of FIG. 16) of approximately 30 degrees with respect to a line that is parallel to the longitudinal axis 1602, for example. The sides 1604 can be slanted toward the tips 1603 at any desired angle (Angle B) or can be substantially not slanted at all.

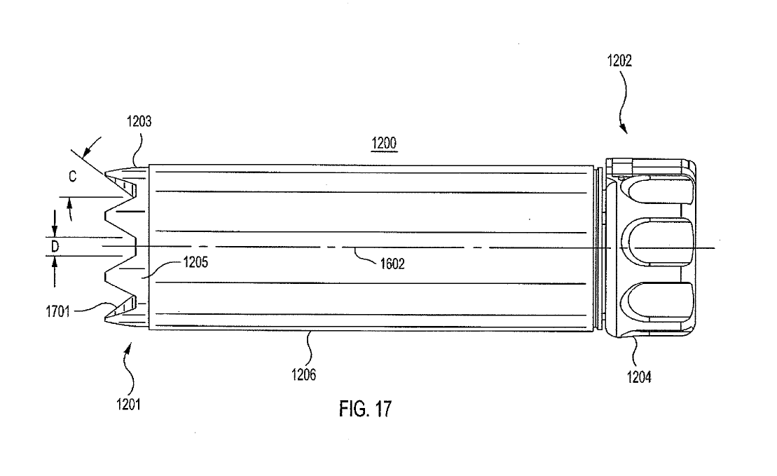

With particular reference to FIG. 17, the protrusions 1203 can have an inner surface 1701. The inner surface 1701 can be slanted outwardly at an angle (Angle C of FIG. 17) of approximately 35 degrees with respect to a line that is parallel to the longitudinal axis 1602, for example. The inner surface 1701 can be slanted outwardly at any desired angle (Angle C) or can be substantially not slanted at all.

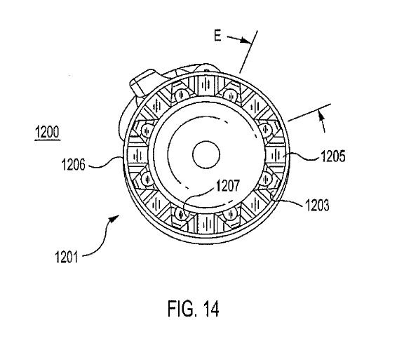

The protrusions 1203 can be spaced apart from one another by an angle (Angle E of FIG. 14) of approximately 45 degrees, for example. The protrusions 1203 can be spaced apart from one another by a distance (Dimension D of FIG. 17) of approximately 0.25 inches, for example.

With particular reference to FIGS. 12 and 14, the protrusions 1203 can have channels, cutouts, openings, or grooves 1207 formed therein. The grooves 1207 can run longitudinally (in a direction generally parallel with respect to the longitudinal axis 1602). The grooves 1207 can be generally circular, semi-circular, or of any other cross-sectional configuration.

One or more of the protrusions 1203 can be configured to puncture a tire of an automobile. For example, the protrusions 1203 can be long enough and sharp enough to puncture a tire of a vehicle. The grooves 1207 can be configured to facilitate the rapid release of air from the tire. For example, the grooves 1207 can be deep enough and wide enough to facilitate substantial air flow therethrough when the protrusions 1203 puncture the tire.

The protrusions 1203 can be formed on a front end cap 1205 of the suppressor 1200. An attachment system 1204 can be provided at the rear of the suppressor 1200. A cylindrical housing 1206 can be disposed between the attachment system 1204 and the front end cap 1205. The attachment system 1204 and/or the front end cap 1205 can be threaded to the cylindrical housing 1206. The attachment system 1204 and/or the front end cap 1205 can be welded, adhesively bonded, riveted, held with fasteners (screws, bolts, etc.) or otherwise attached to the cylindrical housing 1206.

One or more embodiments provide a suppressor 1200 having features that are useful for self-defense, e.g., hand-to-hand combat. One or more embodiments provide a suppressor 1200 having features that are useful for other activities, such as breaking windows, clearing broken glass from windows, flattening vehicle tires, etc.

The protrusions 1203 can be used to gouge or gore an opponent in close quarter combat. The protrusions 1203 can be used to gouge or gore an opponent even when there is little or no room to thrust the firearm 2000. For example, the firearm can be placed into contact with an opponent and can be twisted, without thrusting, so as to cut, gouge, scrape, and/or gore an opponent. In this situation, the suppressor with crenelated front 1200 can have an advantage in close quarters combat with respect to a bayonet, which must generally be thrust toward an opponent.

Protrusions 1203 and/or any other desired structures can be formed on portions of the suppressor 1200 other than the front 1201 thereof. For example, protrusions 1203 can be formed on the housing 1206. The protrusions 1203 or other structures can be configured for any desired purpose. For example, the protrusions 1200 can be for self-defense, can provide heat shielding, and/or can provide enhanced grip (such as while also providing heat shielding).

The protrusions 1203 can define any desired weapon, tool, or other structure. The protrusions 1203 can be used for various different purposes.

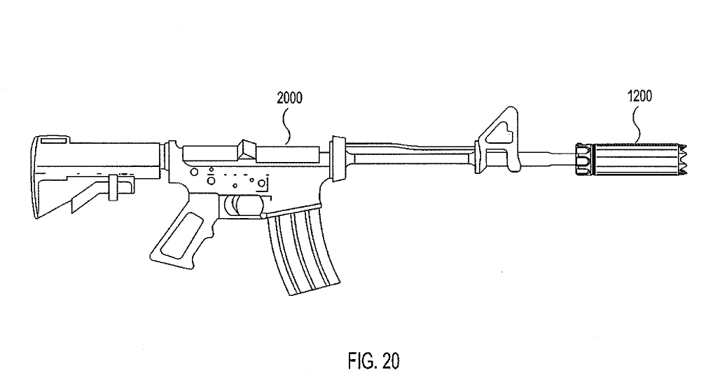

With particular reference to FIG. 20, the suppressor 1200 can be attached to the firearm 2000. The suppressor 1200 can be removably, e.g., temporarily attached to the firearm 2000, permanently attached to the firearm 2000 or can be built in, e.g. integrated, with respect to the firearm 2000. The suppressor 1200 can be threaded to the firearm 2000. The suppressor 1200 can be attached to the firearm 2000 using any suitable method of attachment.

Examples of attachments systems 1204 for removably attaching the suppressor 1200 to the firearm 2000 are discussed below. Such attachment systems are discussed in further detail in United States patent publication no. 2010/0313743 and U.S. Pat. Nos. 6,948,415, 7,676,976 and 7,946,069, the entire contents of all of which are hereby incorporated by reference.

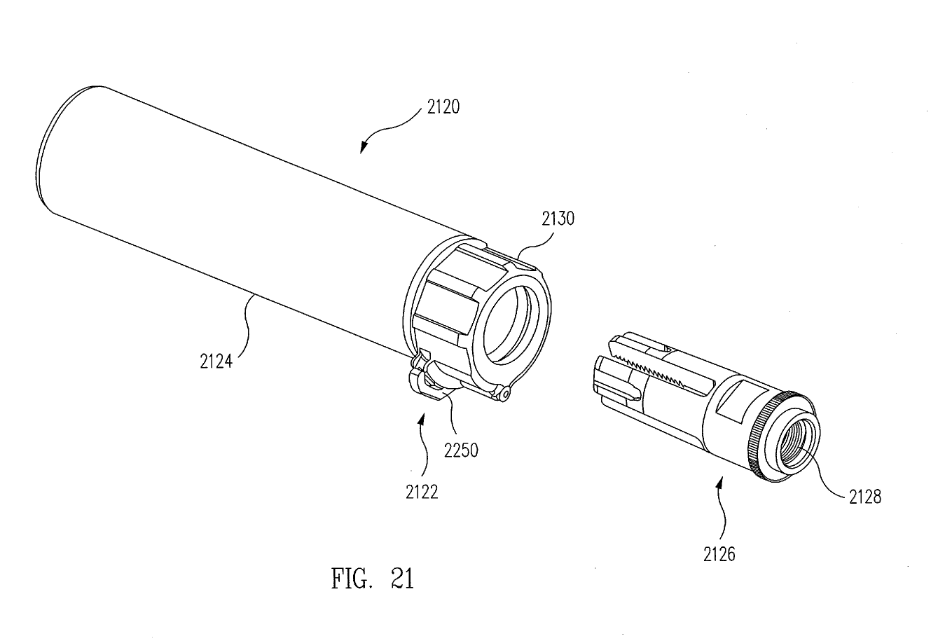

As shown in FIG. 21, there is a noise suppressor 2120, which comprises a locking assembly or attachment system 2122 and a suppressor body 2124. The noise suppressor 2120 is configured to be attached to a muzzle of a firearm 2000 (FIG. 20) via the attachment system 2122. A muzzle flash suppressor 2126 is configured to be attached to a barrel of the firearm 2000 by way of a threaded portion 2128 of the flash suppressor 2126, according to contemporary practice.

In general, the locking assembly 2122 can be utilized in a variety of forms to lock the suppressor body 2124 to the firearm 2000, as discussed in United States patent publication no. 2010/0313743. According to an embodiment, the locking assembly 2122 can comprise a lock ring 2130 that is configured to rotate.

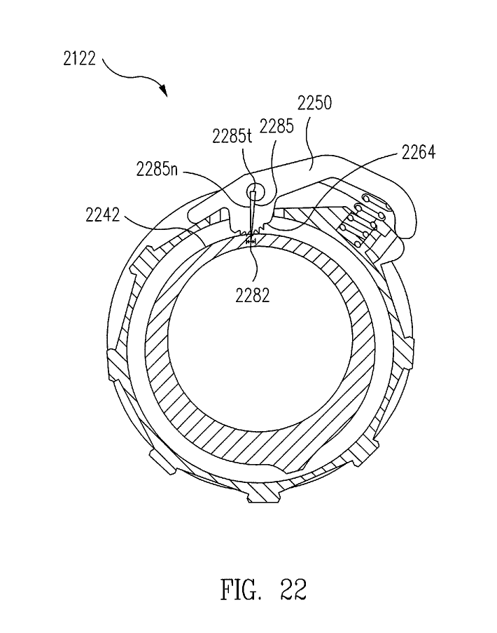

Now referring to FIG. 22, there is shown an embodiment of the locking assembly 2122. With the correct geometries established between the locking lever 2250 and the locking surface 2242, a locked engagement can be provided where it can be appreciated that the amount of force exerted upon the locking surface 2242 by the locking release lever 2250 is indicated by the force vector 2285. In general, the vector 2285 is comprised of the vector components 2285n and 2285t, which represent the normal and tangential force components.

As shown in FIG. 22, the angle of vector 2285n with respect to the vector 2285 can be approximately 10 degrees. A normal force component 2285n and an orthogonal tangential force component 2285t can be provided where the ratio of force values between the normal component to the tangential component is at least 5:1 or greater, such as 10:1 and 20:1 for example. In a broader range this angle can be between 2 degrees and 25 degrees. In general, the distribution of force of the vector 2285 is located in the force engagement region 2282 in a similar manner as discussed above. There is a predetermined amount of surface area being engaged by the surfaces 2264 and 2242.

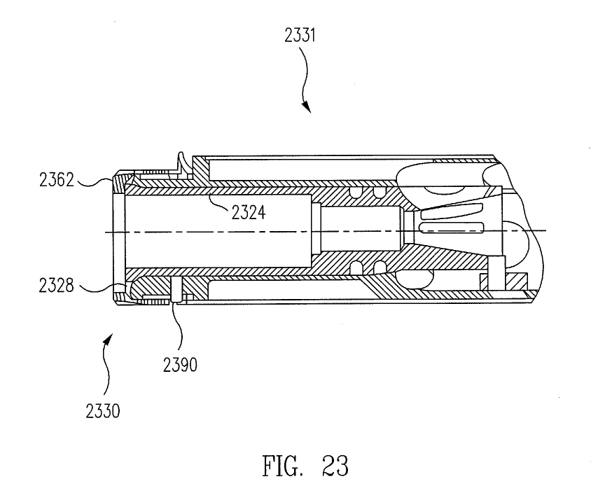

Referring now to FIG. 23, an apparatus can be provided for easily, quickly, and reliably longitudinally securing and rotationally locking the noise suppressor 2331 or another auxiliary device to the muzzle of the firearm 2000, according to an embodiment. For example, a noise suppressor 2331 can be secured to a fixture such as a flash suppressor 2324 that, in turn, is affixed to the muzzle of the firearm 2000.

When installing the suppressor 2331 to the firearm 2000, the attachment system 2330 is placed rearwardly onto the barrel's muzzle such that the flash suppressor 2324 is longitudinally received by the rear section of the suppressor 2331. The user then urges a retainer ring to rotate upon a threaded outer surface of a collar, releasing a second pawl from its engagement with ratchet teeth and placing the retainer ring in its second rotational position whereby a portion 2362 of the ring's radial wall rearwardly contacts a portion of the annular ridge 2328 of the flash suppressor 2324, as described in U.S. Pat. No. 7,946,069. Such rotation also places ratchet teeth in engagement with the pawl, thereby locking the retainer ring against unthreading rotation, effectively locking the noise suppressor 2331 to the flash suppressor 2324 and the barrel of the firearm 2000.

When it is desired to remove the noise suppressor 2331 from the flash suppressor 2324 and thus from the firearm 2000, the user rotates the retainer ring while urging the radially extending pad forwardly to release the pawl from the ratchet teeth. The user continues rotating the retainer ring until the ring's first end surface contacts the projecting stop pin 2390, whereupon the locking bar's second pawl engages one of the ratchet teeth, thereby placing and maintaining the retainer ring in its open position. The user then longitudinally withdraws the noise suppressor 2331 from the flash suppressor 2324 and the firearm 2000.

As used herein, the term “crenellation” can be defined as indentations, notches, space between protrusions, spaces between spikes, or any other structures that define or facilitate the definition of extensions from a body.

As used herein, the term “knife edge” can include both sharp edges and dull edges. A knife edge can be an elongated structure that in some respect at least somewhat resembles an edge of a knife.

Although an M4/M16 type of firearm is shown in the drawings and discussed herein, such is by way of illustration only and not by way of limitation. Embodiments can be used with various different firearms.

Embodiments described above illustrate but do not limit the invention. Thus, it should also be understood that numerous modifications and variations are possible in accordance with the principles of the present invention. Accordingly, the scope of the invention is defined only by the following claims.

I claim:

1. A device comprising:
a suppressor having a front end; and
at least one protrusion extending from the front end of the suppressor.

2. The device as recited in claim 1, wherein the at least one protrusion comprises a plurality of protrusions.

3. The device as recited in claim 1, wherein the least one protrusion comprises a plurality of protrusions that define crenelations between the protrusions.

4. The device as recited in claim 1, wherein the at least one protrusion is a spike.

5. The device as recited in claim 2, wherein:
the protrusions have distal ends; and
the distal ends are blunt.

6. The device as recited in claim 2, wherein:
the protrusions have distal ends;
the distal ends are blunt in one dimension; and
the distal ends have a knife edge in another dimension.

7. The device as recited in claim 2, wherein:
the protrusions have distal ends;
the distal ends are blunt in a first dimension; and
the distal ends have a knife edge in second dimension that is substantially orthogonal with respect to the first dimension.

8. The device as recited in claim 2, wherein the protrusions have channels formed therein.

9. The device as recited in claim 2, wherein:
the protrusions have an outer surface; and
the outer surface is slanted inwardly at an angle of approximately 10 degrees.

10. The device as recited in claim 2, wherein:
the protrusions have an inner surface; and
the inner surface is slanted outwardly at an angle of approximately 35 degrees.

11. The device as recited in claim 2, wherein:
the protrusions have tips and sides; and
the sides are slanted toward the tips at an angle of approximately 30 degrees.

12. The device as recited in claim 2, wherein the protrusions are spaced apart from one another by an angle of approximately 45 degrees.

13. The device as recited in claim 2, wherein the protrusions are spaced apart from one another by an distance of approximately 0.25 inches.

14. A firearm comprising the device as recited in claim 1.

15. The firearm of claim 14, wherein the suppressor is built into the firearm.

16. A method comprising:
providing a suppressor; and
forming at least one protrusion on the suppressor such that the protrusion extends from a front end of the suppressor.

17. The method as recited in claim 16, wherein the at least one protrusion comprises a plurality of protrusions.

18. The method as recited in claim 16, wherein the least one protrusion comprises a plurality of protrusions that define a plurality of crenulations therebetween.

19. The method as recited in claim 16, wherein the at least one protrusion is a spike.

20. A method comprising:
providing a suppressor having at least one protrusion attached to the suppressor such that the protrusion extends from a front end of the suppressor; and
attaching the suppressor to a firearm.
